(19) United States
(12) Patent Application Publication
(10) Pub. No.: US 2017/0118608 A1
(43) Pub. Date: Apr. 27, 2017

(54) REMOTE WAKING METHOD AND SYSTEM

(71) Applicant: Leauto Intelligent Technology (BEIJING) Co., Ltd., Beijing (CN)

(72) Inventor: Yi Chen, Beijing (CN)

(21) Appl. No.: 14/960,313

(22) Filed: Dec. 4, 2015

(30) Foreign Application Priority Data
Oct. 21, 2015 (CN) 201510694814.4

(51) Int. Cl. H04W 4/18

(52) U.S. Cl. CPC H04W 4/18

(57) ABSTRACT

Disclosed are a remote waking method and system, the system includes: a first apparatus, a Beidou ground station and a second apparatus, the second apparatus including a Beidou terminal; wherein the first apparatus is configured to generate a waking instruction and send the waking instruction to the Beidou ground station; the Beidou ground station is configured to encapsulate the waking instruction as a Beidou short message, and forward the Beidou short message to a Beidou terminal in the second apparatus; the Beidou terminal is configured to receive the Beidou short message and send the waking instruction in the Beidou short message to an apparatus controller to make the apparatus controller execute the waking instruction. The present disclosure can solve the problem in the prior art that the remote waking has low efficiency and high cost, and increases the remote waking efficiency and reduces the data traffic cost.

### CROSS-REFERENCE TO RELATED APPLICATIONS

This application is based upon and claims priority to Chinese Patent Application No. CN201510694814.4 filed Oct. 21, 2015, the entire contents of all of which are incorporated herein by reference.

### TECHNICAL FIELD

The embodiments of the present disclosure relate to the technical field of wireless communication, and in particular to a remote waking method and system.

### BACKGROUND

With the development of economic and technology, the functions such as vehicle anti-thief, vehicle remote control and vehicle accident rescue are widely used in vehicles.

During usage of vehicle, a user usually encounters problems such as: the owner of the vehicle stops and parks the vehicle and leave, after he or she leaves for certain distance, the anti-thief system in the vehicle finds that the position of the vehicle is abnormal, for example, the vehicle may be towed away from its original position, the anti-thief system then sends alarm to the owner's mobile phone, to make the owner control the vehicle remotely or further monitor the instant position of the vehicle via mobile phone. However, the functions such as vehicle anti-thief, vehicle remote control and vehicle accident rescue requires a vehicle machine to stay in a working state, the vehicle machine is configured to achieve communication between user and vehicle, and achieve communication between vehicle and the outside world; as a result, it is needed to perform waking operation to the vehicle machine.

Conventionally, a process of waking the vehicle machine remotely is: the user sends a waking instruction to the vehicle via wireless network; a transceiver on the vehicle receives the waking instruction and then sends the waking instruction to a power control module on the vehicle machine through bus technology to execute the waking instruction, thusly waking the vehicle machine. The wireless network may include mobile communication network, such as 2G (2nd-Generation wireless telephone technology), 3G (3rd-Generation mobile communication technology), 4G (4th-Generation mobile communication technology), Wimax (Worldwide Interoperability for Microwave Access) network, RFID (radio frequency identification), Bluetooth network and so on.

However, when using 2G/3G/4G mobile communication networks to wake the vehicle, if the vehicle stops where there is no network signal coverage or the signal-connection is weak, the temporary authority is hard to succeed; thusly remote controlling the vehicle is inefficiency. In addition, users have to pay for the data traffic cost when using 2G/3G/4G network, which results in a high cost.

### SUMMARY

The present disclosure discloses a remote waking method and system, solves the problem in the prior art that the remote waking has low efficiency and high cost, and increases the efficiency of remote waking and reduces the data traffic cost.

The present disclosure provides a remote waking system, including: a first apparatus, a Beidou ground station and a second apparatus connected in sequence, the second apparatus including a Beidou terminal;

wherein the first apparatus is configured to generate a waking instruction and send the waking instruction to the Beidou ground station;

the Beidou ground station is configured to encapsulate the waking instruction as a Beidou short message, and forward the Beidou short message to a Beidou terminal in the second apparatus;

the Beidou terminal is configured to receive the Beidou short message and send the waking instruction in the Beidou short message to an apparatus controller to make the apparatus controller execute the waking instruction.

According to another aspect of the present disclosure, a remote waking method is provided, which includes:

a second apparatus receiving a Beidou short message form a Beidou ground station; the Beidou short message carrying a waking instruction; and

the second apparatus sending the waking instruction in the Beidou short message to an apparatus controller, to make the apparatus controller execute the waking instruction.

According to another aspect of the present disclosure, a terminal apparatus including a Beidou terminal is provided, wherein the Beidou terminal includes:

at least one third processor; and

a third memory for storing at least one instruction executable by the third processor,

wherein the third processor is configured to:
receive a Beidou short message from a Beidou ground station, the Beidou short message carrying a waking instruction; and
send the waking instruction in the Beidou short message to an apparatus controller, to make the apparatus controller execute the waking instruction.

In the remote waking method and system according to the present disclosure, by the step of the first apparatus sending waking instruction to the Beidou ground station, the Beidou ground station forwarding the waking instruction to the second apparatus in the form of Beidou short message, to make the second apparatus execute the waking instruction. Since the Beidou short message has the characteristics of having stable service, having no delay, and not relying on mobile communication network, compared with the conventional technology, it may avoid the problems such as the second apparatus, which may be a vehicle, is hard to be waken when it is located where there is no network signal coverage or the network signal is instable, thusly waking the vehicle machine remotely fast and in time, which increases the efficiency of remote waking the vehicle machine and reduces the data traffic cost of network.

### BRIEF DESCRIPTION OF THE DRAWINGS

In order to more apparently describe the technical schemes in the embodiments of the present disclosure or in the prior art, accompanying figures necessarily used in the description of the embodiments or the prior art will be simply explained hereinafter. Obviously, the accompanying figures described below will form the embodiments of the present disclosure. An ordinary person skilled in the art may conceive further figures in accordance with these accompanying figures without contributing creative labor.

FIG. 1 is a block diagram showing the remote waking system in the first embodiment of the present disclosure;

FIG. 2 is a block diagram showing the remote waking system in the second embodiment of the present disclosure;

FIG. 3 is a flow chart showing the remote waking method in the first embodiment of the present disclosure;

FIG. 4 is a flow chart showing the remote waking method in the second embodiment of the present disclosure;

FIG. 5 is a block diagram showing a terminal apparatus in an embodiment of the present disclosure; and

FIG. 6 is a block diagram showing a Beidou ground station in an embodiment of the present disclosure.

FIG. 7 is a block diagram schematically showing the remote waking system according to the present disclosure.

FIG. 8 is a schematic diagram showing a memory for saving or carrying instructions according to the present disclosure.

### DETAILED DESCRIPTION

In order that objectives, technical schemes and advantages of the embodiments of the present disclosure become more apparent, the technical schemes in the embodiments of the present disclosure will be thoroughly and completely described below in conjunction with the accompanying figures in the embodiments of the present disclosure. It is obvious that the embodiments described herein are some of embodiments of the present disclosure rather than entire embodiments. On the basis of the embodiments of the present disclosure, other embodiments conceived by an ordinary person skilled in the art without creative labor would all fall into the scope of the present disclosure.

An embodiment of the present disclosure may be used in wake apparatus which has been mounted with a Beidou terminal and a Beidou short message function has been provided in the Beidou terminal. The Beidou terminal may be, for example, a terminal apparatus using Beidou second generation satellite navigation system to perform positioning and navigation. The embodiment of the present disclosure does not limit the type of the Beidou terminal. The Beidou short message is a special function of the Beidou satellite navigation system, the function is two-way message transmission between each two of a satellite positioning terminal, a Beidou satellite and a Beidou ground station via satellite signals, and is independent from communication network. In addition, the Beidou short message has the characteristic of having stable service and no delay, compared with the prior art, it may avoid the problem that the remote waking cannot be responded due to instable network signal, and may wake the vehicle remotely fast and in time, which increases the efficiency of remote waking the vehicle, reduces network data traffic cost.

For example, the embodiment of the present disclosure may be adapted to “two buses and a dangerous” vehicles, the “two buses and a dangerous” vehicles may refer to shuttle buses for working in three types, touring buses for travel, and dangerous cargo carrier special vehicles for carrying dangerous chemistry products, fireworks and firecracker, civil explosives. According to regulations such as “National important operating vehicle inspection measures of network spreading system” and “Road transport vehicle satellite positioning system standards conformance technical review” from Ministry of Communications of China, “two buses and a dangerous” vehicles should be equipped with up-to-standard Beidou navigation satellite systems.

Because of mandatory requirement of Ministry of Communications, “two buses and a dangerous” vehicles must be equipped with Beidou terminal, thusly the embodiment of the present disclosure may be directly adapted to “two buses and a dangerous” vehicles. It should be understood that, the embodiment of the present disclosure may also be adapted to any vehicles equipped with the Beidou terminal.

### The First Embodiment

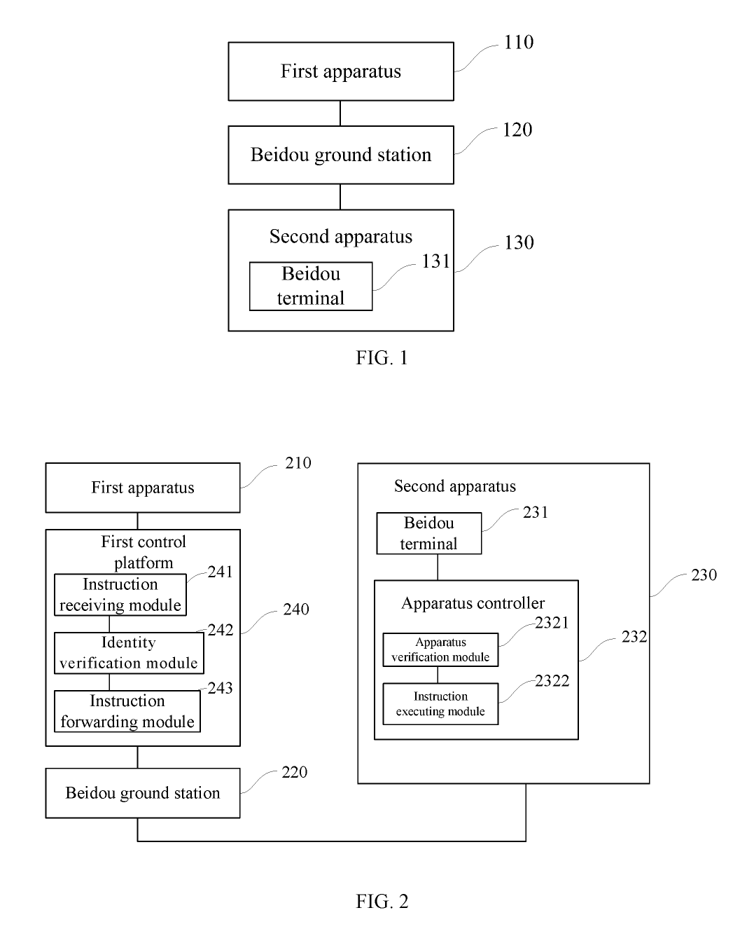

Referring to FIG. 1, it is a block diagram showing the remote waking system in the first embodiment of the present disclosure, and the system may include:

a first apparatus 110, a Beidou ground station 1120 and a second apparatus 130 connected in sequence; the second apparatus may include a Beidou terminal 131;

the first apparatus 110 is configured to generate a waking instruction and send the waking instruction to the Beidou ground station 120.

In an embodiment of the present disclosure, the first apparatus may be any types of mobile terminals such as mobile phone and a tablet computer. The first apparatus may also be other apparatus equipped with Beidou terminal. The second apparatus may be apparatus that needs to be waked, detailedly, it may be an apparatus equipped with the Beidou terminal. The second apparatus receives a waking instruction in the form of Beidou short message via the Beidou terminal, and since the Beidou short message does not rely on network environment, even if the second apparatus is positioned at an area without network signal coverage, it can still receive the waking instruction, thereby solving the problem that the remote waking is restricted by the network state. It should be understood that, in practical application, the present disclosure does not limit the detailed forms of the first apparatus and the second apparatus.

In a practical example of the present disclosure, the first apparatus is a user's mobile phone; the second apparatus is a user's vehicle. When the position of the second apparatus changes, the second apparatus sends an alarm message to the first apparatus, the user receives the alarm message from the first apparatus and knows the state of the second apparatus is abnormal, at that moment, the user may send remote waking instruction to the second apparatus from the first apparatus, to wake the second apparatus, thereby further monitoring the real-time state of the second apparatus.

In detail application, the first apparatus 110 and the Beidou ground station 120 may be connected via network, the first apparatus may send waking instruction to the Beidou ground station related to the second apparatus by message or short message. The network connecting method between the first apparatus and the Beidou ground station may be wired connection, wireless connection and so on; the present disclosure does not limit the connecting ways.

The Beidou ground station 120 is configured to encapsulate the waking instruction as the Beidou short message, and forward the Beidou short message to the Beidou terminal 131 of the second apparatus.

In detail application, the Beidou ground station may upload the Beidou short message to the Beidou satellite, the Beidou ground station is an upload station for navigation satellite ground system, and is capable of injecting the content of the Beidou short message to storage of the Beidou satellite via special radar. The Beidou satellite then issues the Beidou short message to the Beidou terminal of the second apparatus.

The Beidou terminal 131 is configured to receive the Beidou short message, send the waking instruction in the Beidou short message to the apparatus controller to make the apparatus controller execute the waking instruction.

In detail application, the apparatus controller may execute the waking instruction to make a power control module supply power to a target component to wake the target component. In practical application, the target component may be vehicle machine of the vehicle; the present disclosure does not limit the detailed form the target component.

To sum up, in the embodiment of the present disclosure, the first apparatus sends the waking instruction to the Beidou ground station; the Beidou ground station forwards the waking instruction to the second apparatus in the form of the Beidou short message to make the second apparatus execute the waking instruction. Since the Beidou short message has the characteristics of having stable service and no delay, and not relying on mobile communication network, compared with the conventional technology, it may avoid the problem such as the second apparatus, which may be a vehicle, is hard to be waked remotely when it is located where there is no network signal coverage or the signal is instable, thusly can wake the vehicle machine remotely fast and in time, increases the efficiency of remote waking the vehicle machine and reduces the data traffic cost of network.

### The Second Embodiment

Based on the first embodiment, the present disclosure may include the following alternative technical solutions. To increase the safety of the remote waking system, in the current embodiment, the process of identity verification to the waking instruction is added. In the embodiment of the present disclosure, the waking instruction generated by the first apparatus may also include user identification information.

Referring to FIG. 2, it is a block diagram showing the remote waking system in the second embodiment of the present disclosure; which may include:

a first apparatus 210, a first control platform 240, a Beidou ground station 220 and a second apparatus 230 connected in sequence; wherein the first control platform may include: an instruction receiving module 241, an identity verification module 242 and an instruction forwarding module 243, the second apparatus may include a Beidou terminal 231;

the first apparatus 210 is configured to generate a waking instruction, and send the waking instruction to the Beidou ground station;

the Beidou ground station 220 is configured to encapsulate the waking instruction as the Beidou short message, and forward the Beidou short message to the Beidou terminal of the second apparatus;

the Beidou terminal 231 is configured to receive the Beidou short message, send the waking instruction in the Beidou short message to the apparatus controller 232, to make the apparatus controller 232 execute the waking instruction; and

the instruction receiving module 241 is configured to receive the waking instruction from the first apparatus 210;

in an embodiment of the present disclosure, the waking instruction further includes user identification information, in detail application, to guarantee the safety of the remote waking system, users who can use the system should be limited, for example, only registered user can use the remote waking system. Detailedly, the user may register on a first control platform to register the user's identity identification information. By the first control platform, it is capable to manage and control the waking instructions from the user's mobile phones and tablet computers unifiedly, thus avoiding illegal instructions from malicious users to bring safety threat to the remote waking system. It should be understood that, in practical application, the waking instruction may also include identification information of the apparatus which may be waken remotely and bound by the user, by the first control platform, it is also capable to verify the validity of the apparatus identification information, the completeness of the instruction content and so on, the present disclosure does not limit the detailed content of the waking instruction and the method that the first control platform verifies the waking instruction.

The identity verification module 242 is configured to perform match verification to the user identification information in the received waking instruction;

detailedly, the identity verification module may include:

a match verification sub-module, configured to match the user identification information in the waking instruction and the registered user identification information in the first control platform, if the user identification information of the waking instruction exists in the registered user identification information in the first control platform, the identity verification is passed, or the identity verification is failed.

The instruction sending module 243 is configured to send the waking instruction to the Beidou ground station 220 after the identity verification is passed.

In a preferred embodiment of the present disclosure, a second control platform may be added between the first control platform 240 and the Beidou ground station 220. The second control platform may be Beidou satellite control platform which is a national-level control platform. By the Beidou satellite control platform, the embodiment of the present disclosure may verify the identity and the content completeness for a second time, to ensure that the waking instruction sent to the Beidou ground station conforms to the safety requirement of national Beidou satellite navigation system, thusly avoiding instruction message with illegal identity or in-complete content to enter the Beidou ground station.

In another preferred embodiment of the present disclosure, the waking instruction may also include apparatus identification information;

the apparatus controller 232 may include an apparatus verification module 2321;

the apparatus verification module 2321 is configured to match the apparatus identification information in the waking instruction and the identification information of the second apparatus, if match, the apparatus verification is passed, if not, the apparatus verification is fails;

the apparatus controller 232 may further include:

an instruction executing module 2322, configured to execute the waking instruction when the apparatus verification is passed.

In detailed application, when the user sends the waking instruction via his or her mobile phone, he or she may assign the waken apparatus (the second apparatus), that is, the waking instruction may include apparatus identification information which may be configured to label the waken apparatus corresponding to the waking instruction. After the waking instruction is forwarded to the Beidou terminal of the second apparatus via the Beidou ground station, and then arrives at the apparatus controller, the verification module may identify the apparatus identification information in the waking instruction, detailedly, it may match the apparatus identification information of the waking instruction and the hardware number burned in the ROM (read-only memory) of the second apparatus, if match is successful, it is determined that the waking instruction is specific to the vehicle machine of the current vehicle, and then the instruction executing module is informed to execute the waking instruction to make the power control module supply power for the vehicle machine and wake the vehicle machine.

To sum up, in the embodiment of the present disclosure, a first control platform is added between the first apparatus and the Beidou ground station, by verifying the user identity via the first control platform, the safety of the remote waking is ensured. In an embodiment of the present disclosure, the user may firstly register user identification information on the first control platform, only the user identification information that has been registered on the first control platform can pass the identity verification, after passing the identity verification, the first control platform may send the waking instruction to the Beidou ground station, thereby preventing waking instruction sent by illegal user from affecting the safety of the user's apparatus.

### The First Application Example

Hereinafter, the implementing process of the remote waking method in the present disclosure will be illustrated via detailed application examples in accompany with the remote waking system above.

Step S11, the user sends a waking instruction to the first control platform via a mobile phone; the waking instruction includes an user identification information and an apparatus identification information;

in an embodiment of the present disclosure, the first apparatus is a mobile phone, the second apparatus is a user's vehicle, the vehicle is mounted with a Beidou terminal, the waking instruction is a vehicle machine waking instruction specific to the second apparatus. In addition, in an embodiment of the present disclosure, to improve the safety of the remote waking system, a first control platform and a second control platform are added, the first control platform may be connected to the first apparatus and the second control platform via network, respectively. The first control platform may receive vehicle machine waking instruction from the user's mobile phone via network, and forward the vehicle machine waking instruction to the second control platform via network.

In detailed application, the user may send remote vehicle machine waking instruction via APP (a third party application) via the mobile phone, the waking instruction arrives at the first control platform via network.

Step S12, the first control platform performs identity verification to the received waking instruction, after the verification is passed, it sends the waking instruction to the second control platform;

Step S13, the second control platform verifies the identity verification and the content completeness to the received waking instruction, after the verification is passed, it sends the waking instruction to the Beidou ground station;

Step S14, the Beidou ground station encapsulates the waking instruction as a Beidou short message, and forwards the Beidou short message to the Beidou terminal in the second apparatus;

Step S15, the Beidou terminal forwards the waking instruction in the Beidou short message to an apparatus controller;

Step S16, the apparatus controller verifies the apparatus identification information in the waking instruction, after the verification is passed, executing the waking instruction to make the power control module supply power to the vehicle machine to wake the vehicle machine.

### The Third Embodiment

In the embodiment, the detailed implementing process of the remote waking method in the present disclosure is illustrated in the angle of the second apparatus.

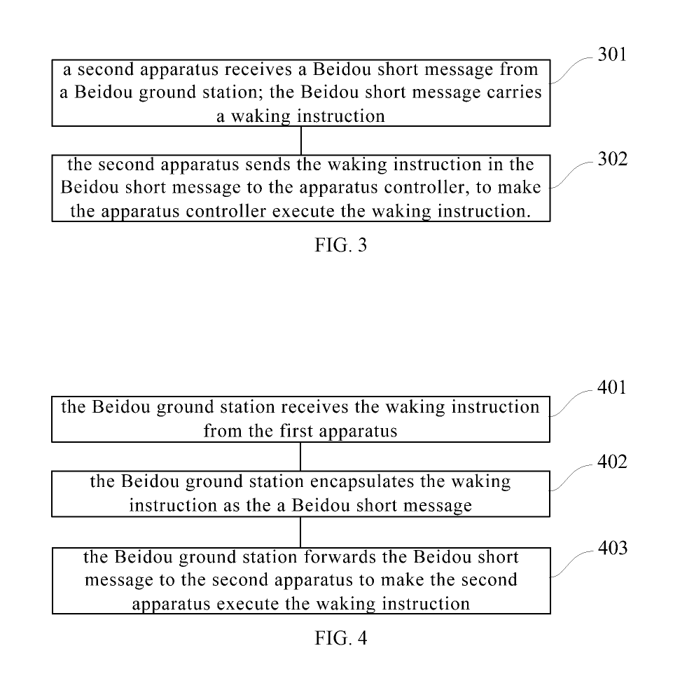

Referring to FIG. 3, it is a flow chart showing the steps of a remote waking method in the first embodiment of the present disclosure, which may include:

Step 301, a second apparatus receives a Beidou short message from a Beidou ground station; the Beidou short message carries a waking instruction;

In an embodiment of the present disclosure, a Beidou terminal in the second apparatus may receive the Beidou short message from the Beidou ground station; the Beidou short message carries the waking instruction specific to the second apparatus.

Step 302, the second apparatus sends the waking instruction in the Beidou short message to the apparatus controller, to make the apparatus controller execute the waking instruction.

In detailed application, after the Beidou terminal receive the Beidou short message from the Beidou ground station, it may send the waking instruction in the Beidou short message to the apparatus controller, the apparatus controller may execute the waking instruction to make the power control module supply power to the target component, thereby waking the target component.

In a preferred embodiment of the present disclosure, the waking instruction may include apparatus identification information;

The step of executing the waking instruction may include:

Step S21, matching the apparatus identification information in the waking instruction with the identification information of the second apparatus;

Step S22, executing the waking instruction when the apparatus identification information in the waking instruction matches the identification information of the second apparatus.

In practical application, after the apparatus controller receives the waking instruction, it may identify the identification information in the waking instruction. Detailedly, it may match the apparatus identification information in the waking instruction and the hardware number burned in the ROM (read-only memory) of the second apparatus, if match is successful, it is determined that the waking instruction is specific to the vehicle machine of the current vehicle, and then the waking instruction is executed to make the power control module supply power for the vehicle machine and wake the vehicle machine.

In the embodiment of the present disclosure, the waking instruction may be received in the form of Beidou short message. Since the Beidou short message has the characteristics of having stable service, having no delay, and not relying on mobile communication network, compared with the conventional technology, it may avoid the problem such as the second apparatus, which may be a vehicle, is hard to be waken when it is located where there is no network signal coverage or the network signal is instable, thusly waking the vehicle machine remotely fast and in time, increases the efficiency of remote waking the vehicle machine and reduces the data traffic cost of network.

### The Fourth Embodiment

In the embodiment, the detailed implementing process of the remote waking method is illustrated in the angle of the Beidou ground station.

Referring to FIG. 4, it is a flow chart showing the steps of the remote waking method in the second embodiment of the present disclosure, which may include:

Step 401, the Beidou ground station receives the waking instruction from the first apparatus;

in an embodiment of the present disclosure, the first apparatus may send a waking instruction specific to the second apparatus to the Beidou ground station via network connection.

Step 402, the Beidou ground station encapsulates the waking instruction as the a Beidou short message;

Step 403, the Beidou ground station forwards the Beidou short message to the second apparatus to make the second apparatus execute the waking instruction.

In detailed application, after the Beidou ground station receives the waking instruction from the first apparatus, it may encapsulate the waking instruction as a Beidou short message, and then forward the Beidou short message to a Beidou terminal of the second apparatus via Beidou satellite to make the second apparatus execute the waking instruction in the Beidou short message received by the Beidou terminal.

To sum up, in the embodiment of the present disclosure, the Beidou ground station encapsulates the waking instruction sent by the first apparatus as the Beidou short message, then forwards the Beidou short message to the second apparatus, to make the second apparatus execute the waking instruction in the Beidou short message. Since the Beidou short message may be forwarded by the Beidou satellite, it does not rely on mobile communication network. Thusly, even if the second apparatus is located where there is no network signal coverage or the signal is instable, it can still receive the waking instruction and thusly ensure the in-time and reliable remote waking.

### First Embodiment of Device

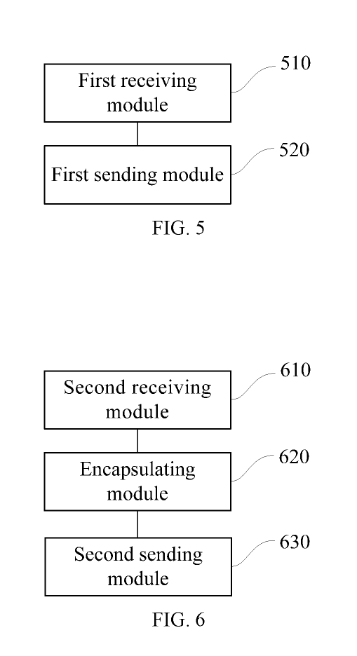

Referring to FIG. 5, it is a block diagram showing a terminal apparatus in an embodiment of the present disclosure; which may include:

a first receiving module 510, configured to receive a Beidou short message from a Beidou ground station; the Beidou short message carries a waking instruction; and

a first sending module 520, configured to send the waking instruction in the Beidou short message to an apparatus controller, to make the apparatus controller execute the waking instruction.

In a preferred embodiment, the waking instruction may include apparatus identification information;

the apparatus controller may include:

an apparatus verification module, configured to match the apparatus identification information in the waking instruction and the identification information of the apparatus, if match, the apparatus verification is passed, if not, the apparatus verification is failed;

an instruction executing module, configured to execute the waking instruction after the apparatus verification is passed.

### Second Embodiment of Device

As shown in FIG. 6, it is a block diagram showing the structure of the Beidou ground station according to an embodiment of the present disclosure, which may include:

a second receiving module 610, configured to receive a waking instruction from a first apparatus;

an encapsulate module 620, configured to encapsulate the waking instruction as a Beidou short message; and

a second sending module 630, configured to forward the Beidou short message to the second apparatus, to make the second apparatus execute the waking instruction.

Each member embodiment of the present disclosure can be realized by hardware, or realized by software modules running on one or more processors, or realized by the combination thereof. A person skilled in the art should understand that a microprocessor or a digital signal processor (DSP) may be used in practical use to realize some or all the functions of some or all the members of the device according to the embodiments of the present disclosure. The present disclosure may be further realized as some or all the equipments or device programs for executing the methods described herein (for example, computer programs and computer program products). This program for realizing the present disclosure may be stored in computer readable medium, or have one or more signal forms. These signals may be downloaded from the Internet website, or be provided by carrying signals, or be provided in any other manners.

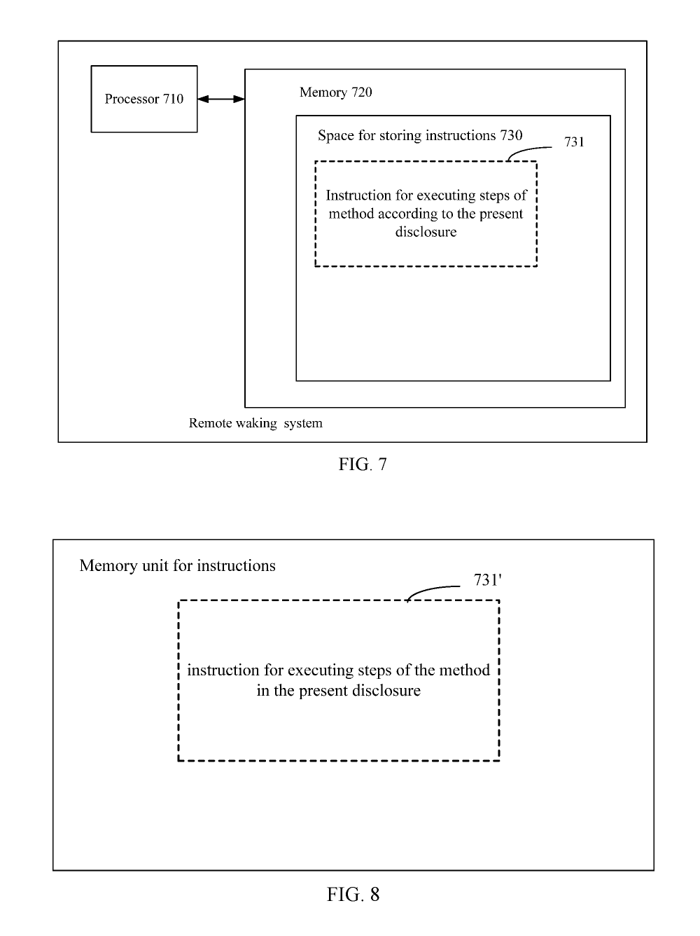

For example, FIG. 7 is a block diagram schematically showing the remote waking system of the present disclosure. The first control platform conventionally includes a processor 710 and a computer program product or computer readable medium in the form of memory 720. The memory 720 may be an electronic memory such as a flash memory, EEPRPOM (electrically erasable programmable read-only memory), EPROM (electrically programmable read-only memory), hard disk or ROM (read-only memory). The memory 720 has a memory space 730 for storing instructions for executing any of the steps in the above method. For example, the memory space 730 for storing the instructions may include each instruction 731 for realizing steps in the above methods respectively. The instruction may be read out from one or more computer program product or write in one or more computer program product. The computer program product includes instruction carrier such as hard disk, compact disk (CD), storage card, or soft disk. The computer program product is usually a portable or non-portable memory unit shown in FIG. 8. The memory unit may have similar-arranged memory paragraph, memory space and the like as the memory 720 of the remote waking system in FIG. 7. The instructions may be, for example, compacted in appropriate form. Generally, the memory unit includes a computer readable code 731′, that is, the code which may be read by processor such as the processor 710. When the instruction is executed by the device for controlling the operation of remote waking system, the remote waking system is made to execute the steps in the methods above.

In an embodiment of the present disclosure, a terminal apparatus is disclosed, the terminal apparatus includes a Beidou terminal, the Beidou terminal may include at least one third processor and a third memory for storing at least one instructions executable by the third processor, the third processor is configured to perform the steps of:

receive a Beidou short message from a Beidou ground station, the Beidou short message carrying a waking instruction; and

send the waking instruction in the Beidou short message to an apparatus controller, to make the apparatus controller execute the waking instruction.

The device embodiment is described above merely for a schematic purpose, wherein the units explained as individual members may or may not be physically separated, the members shown as units may or may not be physical units and they can be located in a place or also can be distributed to network units. As necessary in practice, some or all of the modules can be selected to complete the objectives of the schemes of the embodiments. An ordinary person skilled in the art may understand and implement the embodiments without contributing creative labor.

Through above description of the implementations, it is obvious for the skilled in the art that the implementations can be completed by means of software in connection with necessary universal hardware platform or of course by means of hardware. Based on this understanding, the essence of aforesaid technical schemes or the part contributing to the prior art can be embodied in a form of software product. The computer software product can be stored in computer readable storage medium, such as ROM/RAM, magnetic disc, compact disc and the like, which contains a plurality of instructions such that a computing device (such as, personal computer, server or network apparatus) is able to execute the methods as described in the embodiments or a portion of the embodiment.

In the end, it should be explained that aforesaid embodiments are provided for the illustrative not limiting purpose of the technical schemes of the present disclosure. Although the present disclosure has been described in detail with reference to the embodiments, it should be understood that modifications or equivalent substitutions can be made to the technical schemes or some of technical features therein as disclosed in the embodiments by those skilled in the art; the modifications or substitutions will not bring the essence of the respective technical schemes to depart from spirit and scope of the technical schemes of the inventive embodiments.

1. A remote waking system, comprising: a first apparatus, a Beidou ground station and a second apparatus connected in sequence, the second apparatus comprising a Beidou terminal;
wherein the first apparatus is configured to generate a waking instruction and send the waking instruction to the Beidou ground station;
the Beidou ground station is configured to encapsulate the waking instruction as a Beidou short message, and forward the Beidou short message to a Beidou terminal in the second apparatus;
the Beidou terminal is configured to receive the Beidou short message and send the waking instruction in the Beidou short message to an apparatus controller to make the apparatus controller execute the waking instruction.

2. The system according to claim 1, wherein the waking instruction comprises user identification information; the system further comprises a first control platform connected between the first apparatus and the Beidou ground station, the first control platform comprises:
at least one first processor; and
a first memory for storing at least one instruction executable by the first processor,
wherein the first processor is configured to:
receive the waking instruction from the first apparatus;
perform a matching verification to the user identification information in the received waking instruction; and
send the waking instruction to the Beidou ground station after identity verification is passed.

3. The system according to claim 2, wherein the first processor is further configured to:
match the user identification information in the waking instruction and registered user identification information in the first control platform, if the user identification information in the waking instruction exists in the registered user identification information in the first control platform, the identity verification is passed, or the identity verification is failed.

4. The system according to claim 1, wherein the waking instruction further comprises apparatus identification information;
the apparatus controller comprises:
at least a second processor,
a second memory for storing at least one instruction executable by the second processor,
wherein the second processor is configured to:
match the apparatus identification information in the waking instruction and identification information of the second apparatus, if match, the apparatus verification is passed, if not match, the apparatus verification is failed; and
execute the waking instruction after the apparatus verification is passed.

5. A remote waking method, comprising:
a second apparatus receiving a Beidou short message form a Beidou ground station; the Beidou short message carrying a waking instruction; and
the second apparatus sending the waking instruction in the Beidou short message to an apparatus controller, to make the apparatus controller execute the waking instruction.

6. The method according to claim 5, wherein the waking instruction comprises apparatus identification information;
the step of executing the waking instruction comprises:
matching apparatus identification information in the waking instruction and identification information of the second apparatus; and
executing the waking instruction when the apparatus identification information in the waking instruction matches the identification information of the second apparatus.

7. A terminal apparatus comprising a Beidou terminal; wherein the Beidou terminal comprises:
at least one third processor; and
a third memory for storing at least one instruction executable by the third processor,
wherein the third processor is configured to:
receive a Beidou short message from a Beidou ground station, the Beidou short message carrying a waking instruction; and
send the waking instruction in the Beidou short message to an apparatus controller, to make the apparatus controller execute the waking instruction.

8. The terminal apparatus according to claim 7, wherein the waking instruction comprises apparatus identification information;
the apparatus controller comprises:
at least one fourth processor; and
a fourth memory for storing at least one instruction executable by the fourth processor,
wherein the fourth processor is configured to:
match the apparatus identification information in the waking instruction and identification information of the apparatus, if match, apparatus verification is passed, if not, the apparatus verification is failed;
execute the waking instruction when the apparatus verification is passed.
